(19) United States
(12) Patent Application Publication
(10) Pub. No.: US 2007/0242820 A1
(43) Pub. Date: Oct. 18, 2007

(54) Rotating mechanism for electronic device

(75) Inventor: Yi-Hsiang Tseng, Jhonghe City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/730,846

(22) Filed: Apr. 4, 2007

(30) Foreign Application Priority Data
Apr. 14, 2006 (TW) 095113431

(51) Int. Cl. H04M 1/00

(52) U.S. Cl. 379/433.12

(57) ABSTRACT

A rotating mechanism comprises a base, a rotating device and a rebound device. The base includes a base body, a base joint and a first shaft. The base joint and the first shaft are disposed on the base body respectively. The rotating device includes a rotating device joint. The rotating device is capable of rotating the first shaft. The rotating device joint is able to circle around the first shaft. Two ends of the rebound device are pivotally connected to the base joint and the rotating device joint respectively. The rebound device is capable of deforming and rotating the base joint and the rotating device joint.

### BACKGROUND OF THE INVENTION

1. Field of the Invention

The present invention generally relates to a rotating mechanism. More particularly, the present invention relates to a rotating mechanism for rotating a top cover on an electronic device.

2. Description of the Prior Art

When the consumers are purchasing a consuming electronic device, not only the size and the function but also the design and the convenience of the consuming electronic device are the common requirements for the customers. Especially in the mobile phone market, the swiveled mobile phone is one of the most popular mobile phone that customers like.

In a swiveled mobile phone, there is a top cover used to cover the swiveled mobile phone. Generally, the display screen of the mobile phone is in the upper portion of the top cover and the buttons are in the mobile phone body. When the top cover of the mobile phone is swiveled to turn on the mobile phone, the mobile phone is in active mode. When the top cover is swiveled to turn off the mobile phone, the mobile phone is in sleep mode. Because the display screen and the buttons are in different surfaces, the size of the button and the region of the display screen can be increased; therefore, the usage convenience is increased. Furthermore, the beauty of the mobile phone is enhanced and the used space of the mobile phone is increased by rotating the top cover to turn on or off the mobile phone. The idea of the swiveled phone can also be implemented in electronic dictionary, MP3 player, digital camera, personal digital assistant (PDA) and so on.

At the present day, the top cover of the swiveled phone in the market is designed for rotating manually. The manual swiveling is to swivel the top cover manually to open the mobile phone. However, the way to manually swivel the mobile phone is not very convenient and is needed to improve.

### SUMMARY OF THE INVENTION

The main purpose of the present invention is to provide a rotating device. The rotating device is used to enhance the usage convenience to move an object by a rotating method.

The other purpose of the present invention is to provide a rotating device of a top cover of an electronic device and enhance the usage convenience of the top cover of the electronic device.

The rotating mechanism of the present invention includes a base, a rotating device and a rebound device. The base includes a base body, a base joint and a first shaft. The base joint and the first shaft are respectively disposed on the base body.

The rotating device includes a rotating device joint and is disposed rotatedly relative to the first shaft and the rotating device joint is capable of rotating around the first shaft.

Two ends of the rebound device are pivots on the base joint and the rotating device joint respectively. The rebound device is capable of deforming while rotating around the base joint and the rotating device joint.

In the preferred embodiment, the rotating device further includes an auxiliary device disposed on the rotating device and movably contact with the base body to keep a fixed distance between the rotating device and the base body. The auxiliary device can be a wheel or a rolling ball.

The rebound device includes a sleeve, a rod and a force generator. The sleeve includes an opening end and a pivot end. The opening end has a sleeve opening and the pivot end is connected to the base joint. The rod axially and movably disposed within the sleeve, and one end of the rod extends out from the sleeve opening and connects to the rotating device joint. The force generator is disposed between the rod and the pivot end of the sleeve.

### BRIEF DESCRIPTION OF THE DRAWINGS

FIG. 1 is a view of an embodiment of the present invention.

FIG. 2a is an exploded view of the embodiment of the present invention.

FIG. 2b is an exploded view of another embodiment of the present invention.

FIG. 2c is an exploded view of the other embodiment of an auxiliary device of the present invention.

FIGS. 3a-3b are exploded views of a rebound device in the present invention.

FIG. 4 is a view of a swiveled mobile phone applied in the present invention.

FIGS. 5a-5c are views of a swiveled mobile phone of the present invention.

FIG. 6 is a view of another embodiment showing a rotating device, a rebound device, a base joint and a rotating device joint are disposed alone on the mobile phone of the present invention.

FIG. 7 is a view of a base body being molded to the mobile phone body in the present invention.

### DETAILED DESCRIPTION OF THE PREFERRED EMBODIMENT

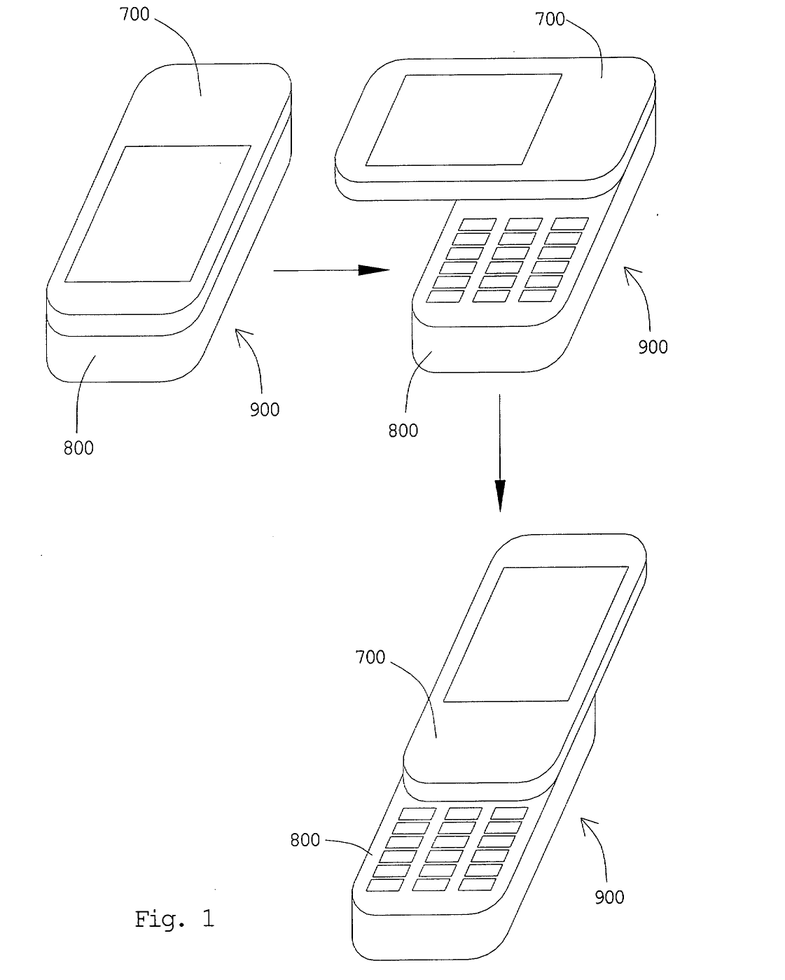

A rotating mechanism 100 is disclosed in the present invention. As the preferred embodiment showing in FIG. 1, the rotating mechanism 100 is used for rotating a top cover 700 of a swiveled mobile phone 900. In a different embodiment, the rotating mechanism 100 is used in a swiveled electronic device.

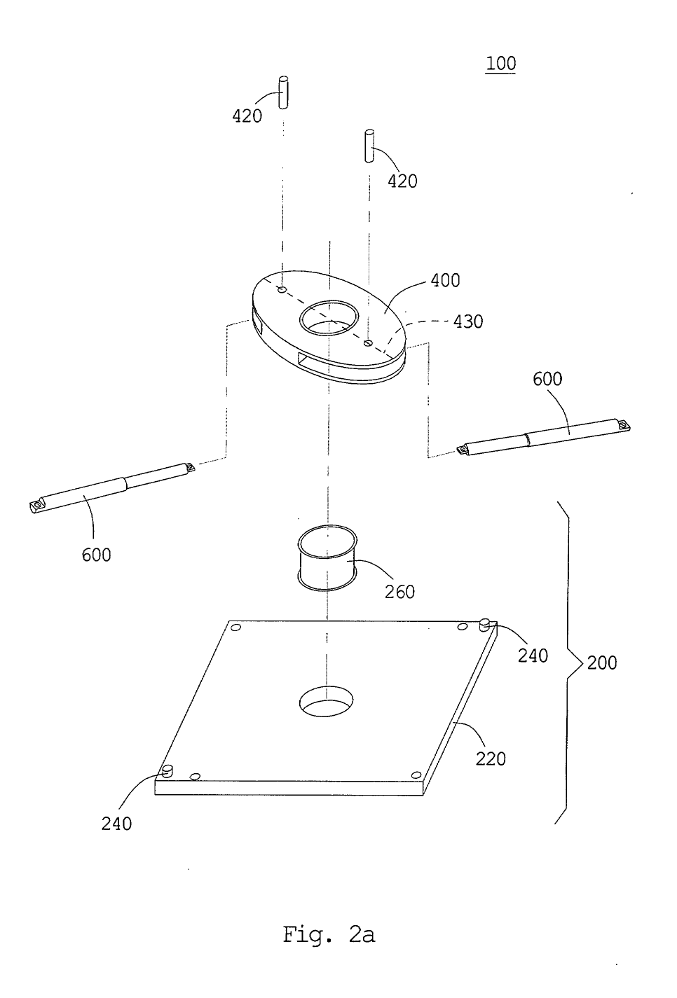

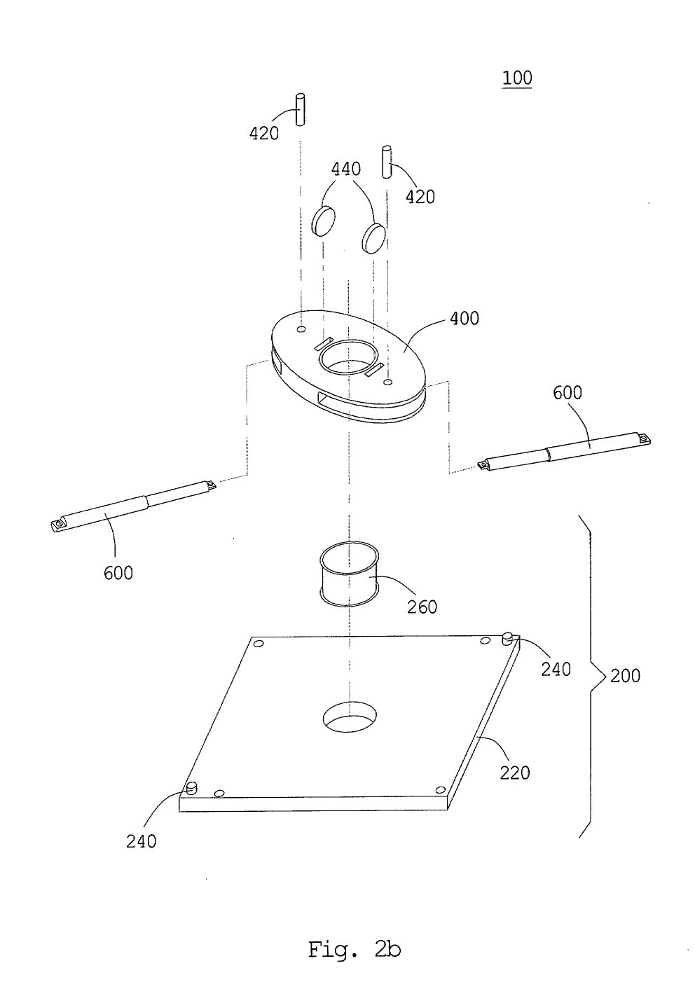

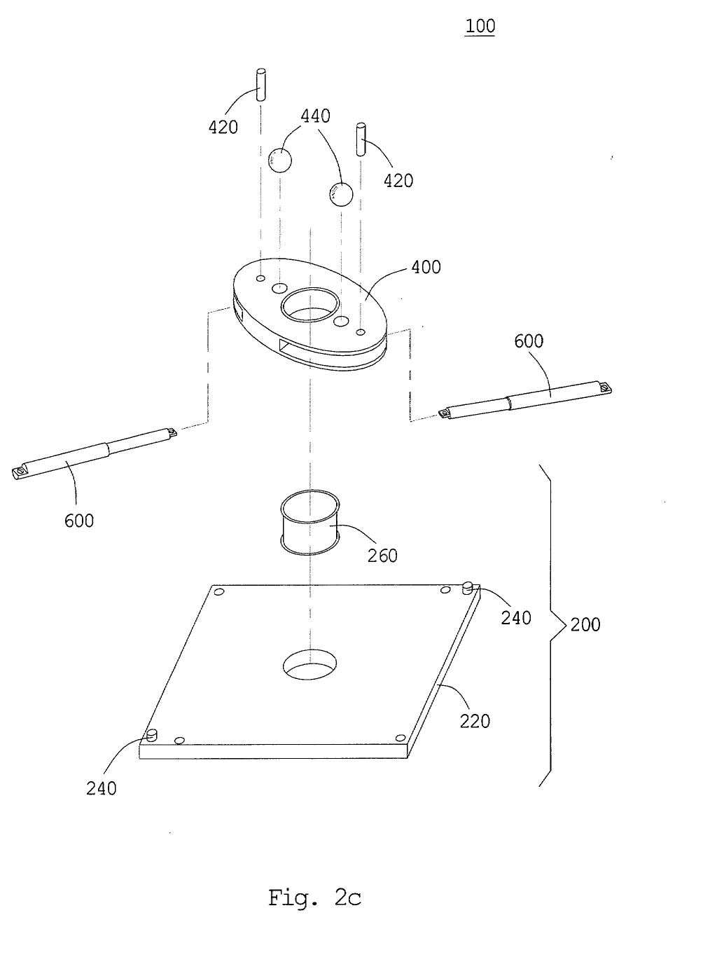

FIG. 2a is an exploded diagram showing a preferred embodiment. The rotating mechanism 100 of the present invention includes a base 200, a rotating device 400 and a rebound device 600. The base 200 includes a base body 220, a base joint 240, and a first shaft 260. The base joint 240 and the first shaft 260 are respectively disposed on the base body 200. The base body 220 is a flat piece object or a block piece object with a square, circle, triangle or irregular shape. In the preferred embodiment, the base body 220 is a square-shaped flat piece object. The first shaft 260 is a cylinder and is coupled between the rotating device 400 and the base body 220. The first shaft 260 is preferably disposed in the center of the base body 220. In a different embodiment, the first shaft 260 is disposed in other location on the base body 220.

The base joint 240 is coupled to one end of the rebound device 600. In order to reduce the friction generated by swiveling the rebound device 600 relative to the base joint 240, the base joint 240 is preferable to be a cylinder. In a different embodiment, the base joint 240 is a triangle, circle or any other polygon of block. The base joint 240 is disposed in a place located anywhere outside the first joint 260 of the base body 220, and the base joint 240 is preferably located in the corner of the base body 220.

As showing in FIG. 2a, the rotating device 400 is an oval-shaped plate. In a different embodiment, the rotating device 400 is a flat piece object or a block piece object with a square, circle, triangle or irregular shape. The rotating device 400 is disposed on the first shaft 260 and is rotating relative to the first shaft 260. The first shaft 260 is in the center and coupled to the rotating device 400, while the rotating device 400 is coupled to the base body 220. The rotating device 400 includes a rotating device joint 420. When the rotating device 400 is rotating relative to the center of the first shaft 260, the rotating device joint 420 and the rotating device 400 are moving together.

The rotating device joint 420 is coupled to the other end of the rebound device 600. In order to reduce the friction generated by the rebound device 600 rotating in the rotating device joint 420, the rotating device joint 420 is a cylinder. In a different embodiment, the rotating device joint 420 is a triangle, circle or any other polygon of block. The rotating device joint 420 is disposed in anywhere instead of the position of the first joint 260 of the rotating device 400 and preferably disposed on the oval-shaped long axle 430 of the oval-shaped rotating device 400. The rotating device 400 is connected to the top cover of the portable electronic device. In a different embodiment, the rotating device 400 can be the top cover of the portable electronic device.

The two ends of the rebound device 600 are respectively coupled to the base joint 240 and the rotating device joint 420. The rebound device 600 is capable of deforming while it is rotating around the base joint 240 and the rotating device joint 420. When the rotating device 400 is rotating in the first shaft 260, one end of the rebound device 600 is moving together with the rotating device joint 420 and rotating around the first shaft 260. At the same time, the rebound device 600 is rotating around the base joint 240.

FIG. 2b is an exploded diagram showing an embodiment. The rotating device 100 of the present invention further includes an auxiliary device 440. The auxiliary device 440 is disposed on the rotating device 400 and capable of rotating at a fixed distance around the first shaft 260 on the surface of the base 200. As shown in FIG. 2b, the auxiliary device 440 is a wheel. The pivot of the wheel is vertical to the first shaft 260. A portion of the wheel is exposed outside of the rotating device 400 and disposed between the rotating device 400 and the base 200. When the rotating device 400 is rotating around the first shaft 260, the wheel is rolling around the first shaft 260 at a fixed distance on the surface of the base 200 in order to reduce the friction between the rotating device 400 and the base 200. In a different embodiment, a different type of auxiliary device 440 is used to reduce the friction between the rotating device 400 and the base 200. FIG. 2c is an exploded diagram showing another embodiment. The auxiliary device 440 is a rolling ball. The rolling ball is disposed in the rotating device 400. A portion of rolling ball is exposed outside of the rotating device 400 and disposed between the rotating device 400 and the base 200. When the rotating device 400 is rotating around the first shaft 260, the rolling ball is rolling around the first shaft 260 at a fixed distance on the surface of the base 200, in order to reduce the friction between the rotating device 400 and the base 200.

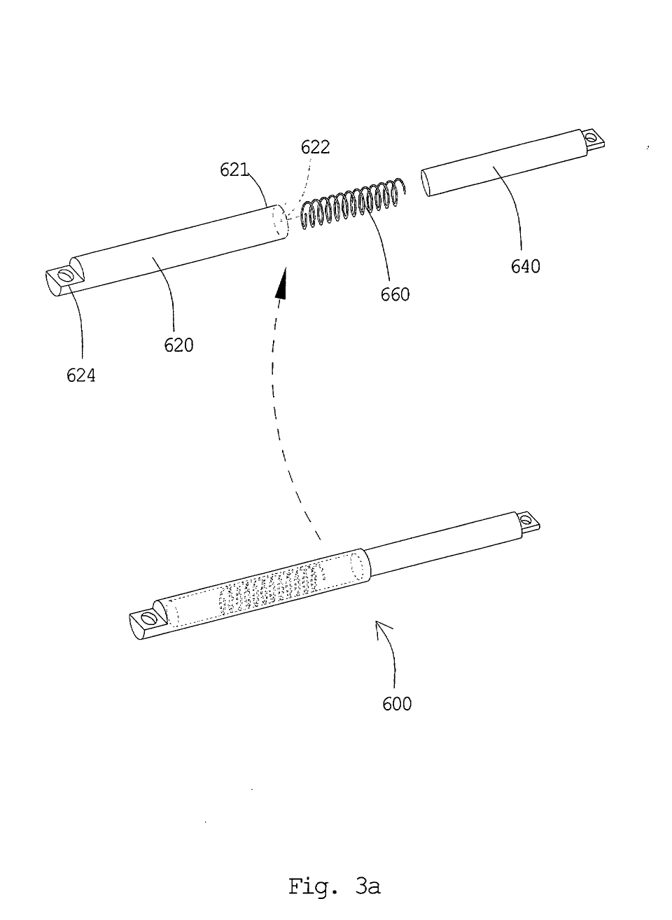

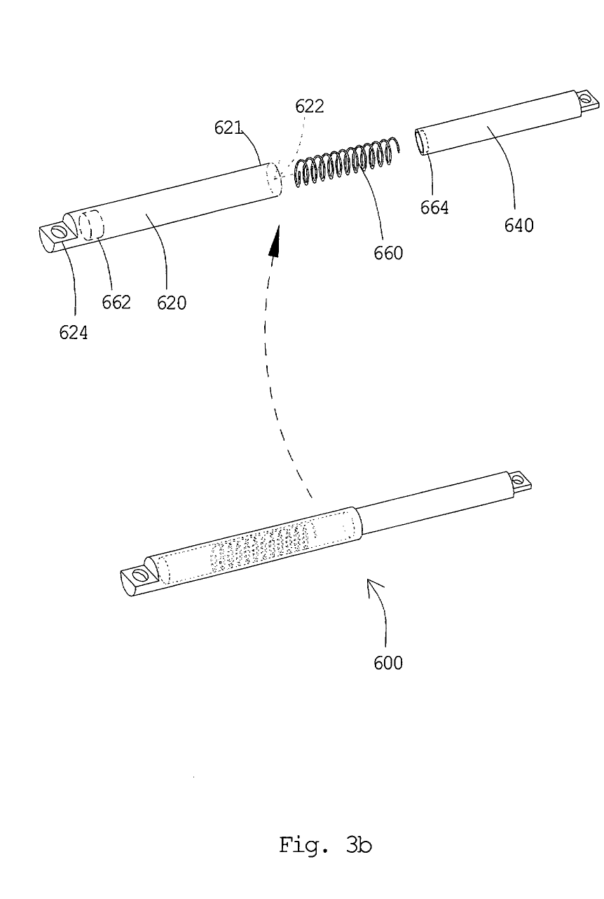

As a preferred embodiment shown in FIG. 3a, the rebound device 600 of the present invention includes a sleeve 620, a rod 640 and a force generator 660. The sleeve 620 includes an opening end 621 and a pivot end 624. The opening end 621 includes a sleeve opening 622. The opening end 621 is coupled to the base joint 240. The rod 640 can be pivotally moved within the sleeve 620. The one end of the rod 640 is extended out from the sleeve opening 622 and connected to the rotating device joint 420. In a different embodiment, the pivot end 624 of the sleeve 620 is pivotally connected to the rotating device joint 420. One end of the rod 640 is pivotally connected to the base joint 240.

As a preferred embodiment shown in FIG. 3a, the rebound device 600 is disposed between the rod 640 and the pivot end 624 of the sleeve 620. In the preferred embodiment, the rebound device 600 is a spring. In a different embodiment, the rebound device 600 is a component made by rubber or other resilient materials. Besides, in a different embodiment, the rebound device 600 is a magnetic component, such as magnet, metal and so on. As an embodiment shown in FIG. 3b, the force generator 660 includes a sleeve magnetic component 662 and a rod magnetic component 664. The sleeve magnetic component 662 is disposed in a position adjacent to the pivot end 624 and within the sleeve 620. The rod magnetic component 664 is disposed within the rod 640 and extending to one end of the sleeve 620. The sleeve magnetic component 662 and the rod magnetic component 664 have the same magnetic characteristic.

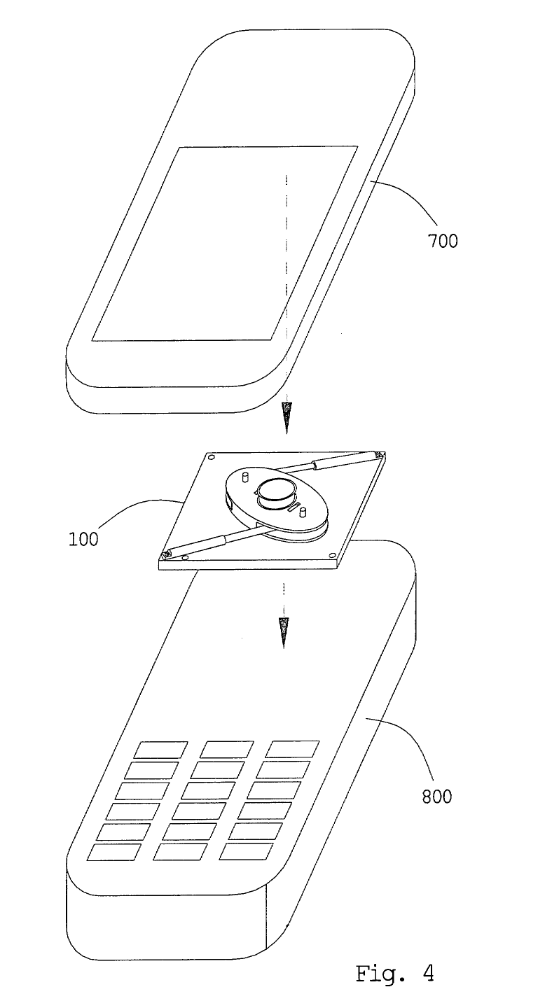

The rotating mechanism 100 of the electronic device is disclosed in the present invention. As a preferred embodiment shown in FIG. 4, the base 200 of the rotating mechanism 100 is connected or molded to a body 800 of a mobile phone 900. The rotating device 400 of the rotating mechanism 100 is connected or molded to a top cover 700 of a mobile phone 900. The electronic device is a digital camera, an electronic dictionary, a MP3 player, a personal digital assistant (PDA) and so on.

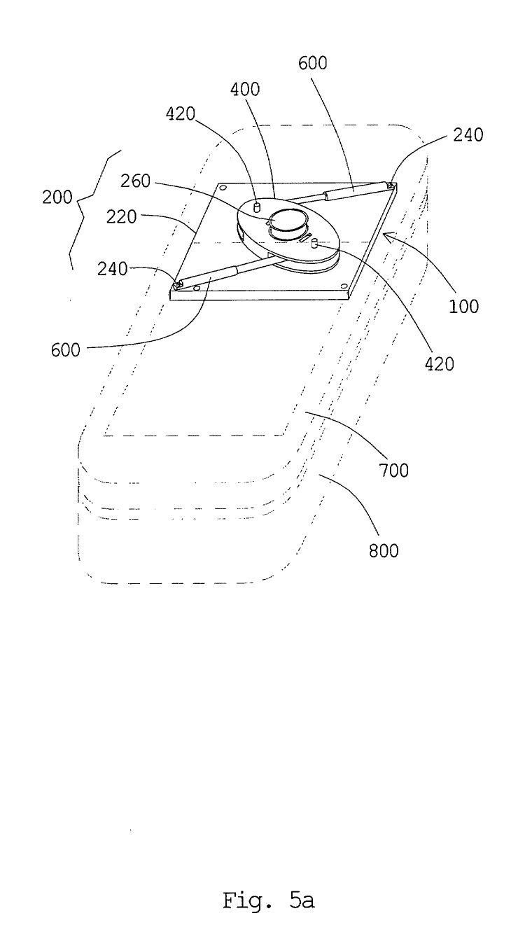

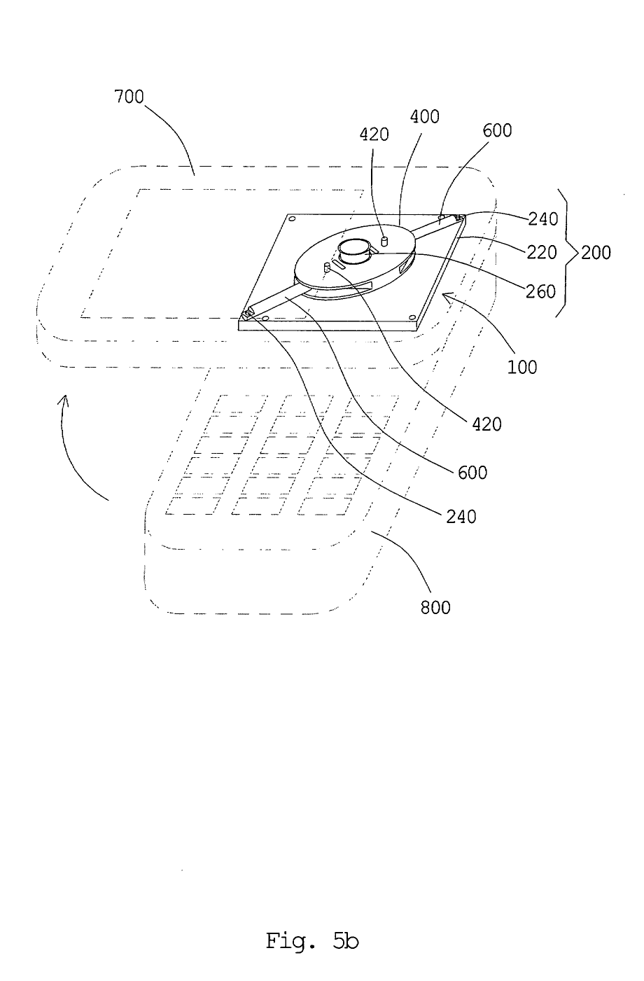

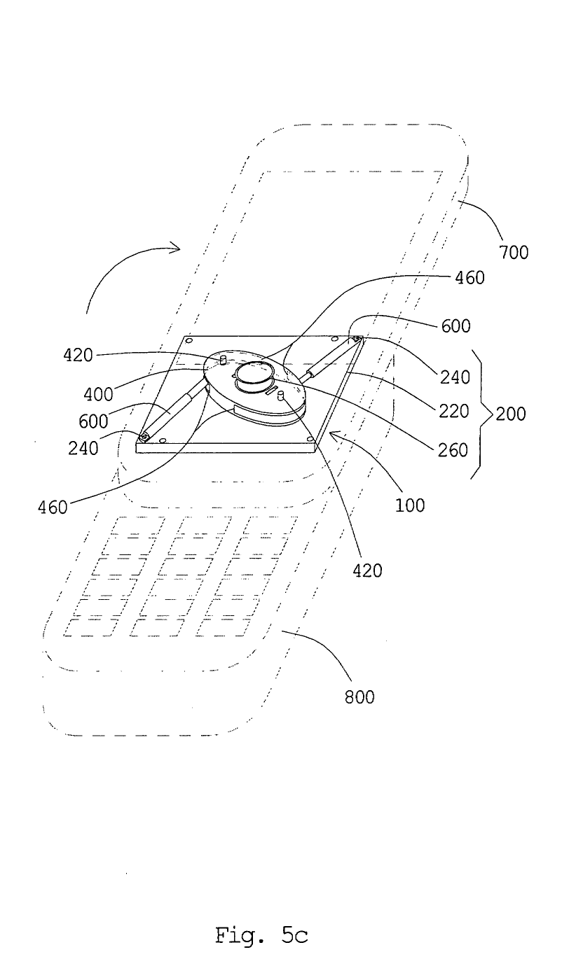

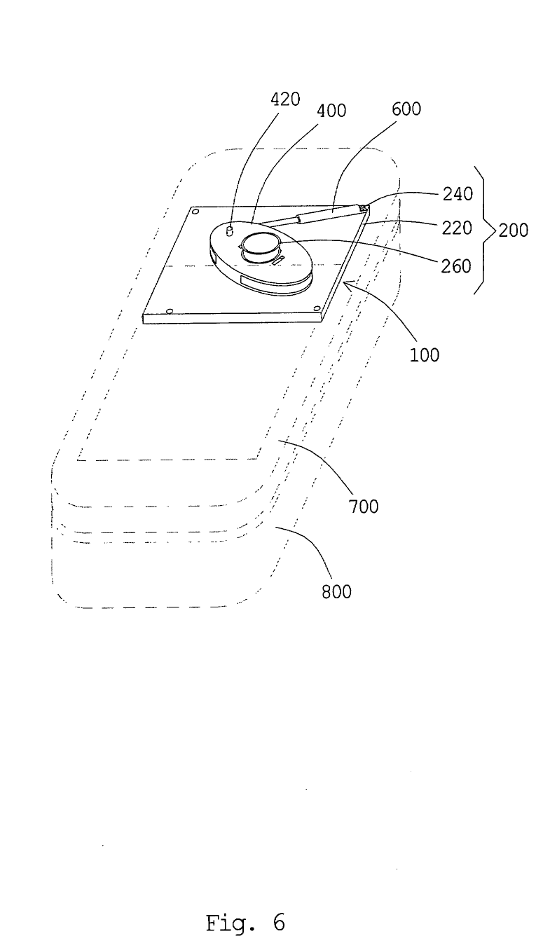

FIG. 5a and FIG. 5c are views showing the preferred embodiment of the rotating mechanism of the present invention. As the preferred embodiment shown in FIG. 5a, the mobile phone top cover 700 is stacked on the mobile phone body 800. The top cover 700 and the body 800 are closed. The top cover 700 protects the buttons of the body 800 and the mobile phone 900 is in sleep mode to save the battery energy.

As the preferred embodiment shown in FIG. 5b, the mobile phone top cover 700 is outwardly pushed and a depressed deformation is generated by the rebound device 600. When the rotating device joint 420 is disposed between the first shaft 260 and the base joint 240 and the first shaft 260 is aligned with the base joint 240, the most depressed deformation is generated by the rebound device 600.

In FIG. 5b, a rebounded strength is generated by the depressed deformation of the rebound device 600. The rotating mechanism 100 is in an unstable status. As the embodiment shown in FIG. 5c, the rotating joint device 420 is in the position shown in FIG. 5b and the rebounded strength generated by the depressed deformation of the rebound device 600 will force the top cover 700 to keep rotating. The rebounded strength generated by the depressed deformation of the rebound device 600 is becoming smaller and smaller when the top cover 700 is kept moving up. When the top cover 700 is moving to a position paralleled to the mobile phone body 800, the rebound device 600 is in the status as the top cover 700 is stacked on the mobile phone body 800.

As the embodiment shown in FIG. 5c, the rebound device 600 of the rotating mechanism 100, the base joint 240 of the rebound device 600 and the rotating joint 420 are disposed by forming a pair to have better balance, stability and durability. In a different embodiment, the rebound device 600 of the rotating mechanism 100, the base joint 240 of the rebound device 600 and the rotating joint 420 are respectively disposed alone.

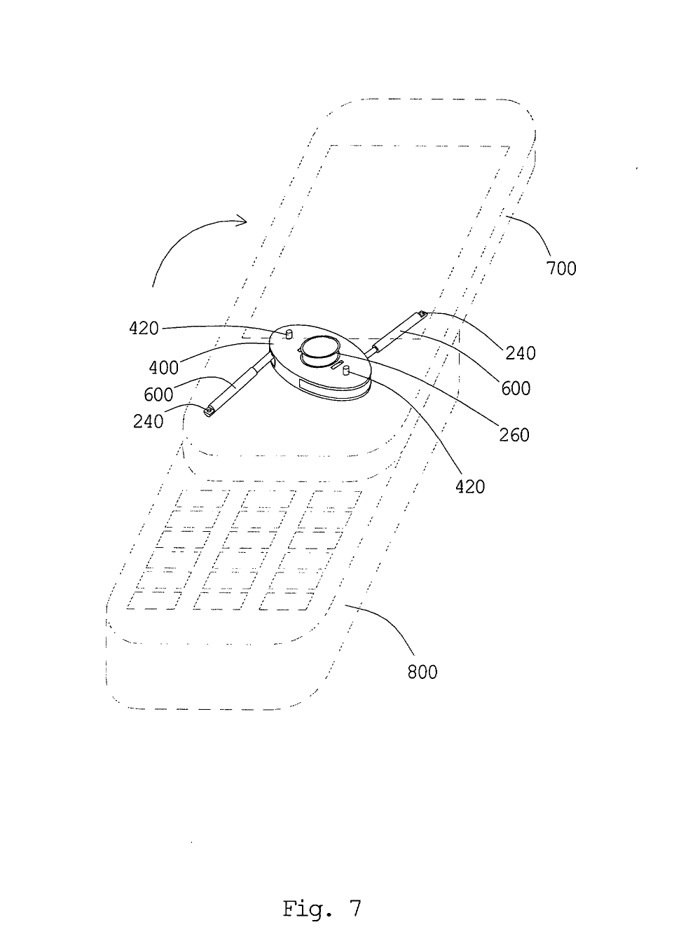

As the preferred embodiment shown in FIG. 5c, the base 200 of the present invention is connected to the mobile phone body 800. The connective method includes screwing, molding, wedging, gluing and so on. In a different embodiment shown in FIG. 7, the mobile phone body 800 is designed to embrace the base 200 and the base joint 240 and the pivot joint 260 are disposed on the mobile phone body 800.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A rotating mechanism comprising:
a base including a base body, a base joint and a first shaft, wherein the base joint and the first shaft are respectively disposed on the base body;
a rotating device including a rotating device joint capable of rotating around the first shaft; and
a rebound device, two ends of the rebound device pivoting on the base joint and the rotating device joint respectively; wherein the rebound device is deformed while rotating relatively to the base joint and the rotating device joint.

2. The rotating mechanism of claim 1, wherein the rotating device is capable of rotating around the first shaft.

3. The rotating mechanism of claim 1, wherein the rotating device further includes an auxiliary device disposed on the rotating device and movably contact with the base body to keep a fixed distance between the rotating device and the base body.

4. The rotating mechanism of claim 3, wherein the auxiliary device includes a wheel.

5. The display panel structure of claim 3, wherein the auxiliary device includes a rolling ball.

6. The rotating mechanism of claim 1, wherein the rebound device generates a compression deformation when the rotating device joint is located between the first shaft and the base joint and aligned with the first shaft and the first base joint.

7. The rotating mechanism of claim 1, wherein the rebound device includes:
a sleeve having an opening end and a pivot end, the opening end having a sleeve opening and the pivot end connected to the base joint;
a rod axially and movably disposed within the sleeve; wherein one end of the rod extends from the sleeve opening and connects to the rotating device joint; and
a force generator disposed between the rod and the pivot end of the sleeve.

8. The rotating mechanism of claim 7, wherein the rod makes the force generator to compress to generate a rebounded force when the rotating device joint, the first shaft and the base joint are aligned.

9. The rotating mechanism of claim 7, wherein the force generator includes a spring.

10. The rotating mechanism of claim 7, wherein the force generator includes a pair of magnetic elements with the same magnetic characteristic.

11. The rotating mechanism of claim 1, wherein the rebound device comprises:
a sleeve including an opening end and a pivot end and the opening end is in a sleeve opening and the pivot end is connected to the rotating device joint;
a rod axially and movably disposed within the sleeve and one end of the rod is extended from the sleeve opening and connected to the rotating device joint; and
a force generator disposed between the rod and the pivot end of the sleeve.

12. An electronic device comprising:
an electronic device body;
a base including a base body, a base joint and a first shaft and the base joint and the first shaft are respectively disposed in the base body and the base is connected to the electronic device body;
a rotating device including a rotating device joint capable of rotating around the first shaft; and
a rebound device, two ends of the rebound device pivoting on the base joint and the rotating device joint respectively; wherein the rebound device is deformed why rotating relative to the base joint and the rotating device joint.

13. The electronic device of claim 12, wherein the rotating device is capable of rotating the first shaft.

14. The electronic device of claim 12, wherein the rotating device is an upper cover of the electronic device.

15. The electronic device of claim 12, wherein the rotating device further includes an auxiliary device disposed on the rotating device and movably contact with the base body to keep a fixed distance between the rotating device and the base body.

16. The electronic device of claim 12, wherein the auxiliary device includes a wheel.

17. The electronic device of claim 12, wherein the auxiliary device includes a rolling ball.

18. The electronic device of claim 12, wherein the rebound device generates a compression deformation when the rotating device joint is located between the first shaft and the base joint and aligned with the first shaft and the first base joint.

19. The electronic device of claim 12, wherein the rebound device comprises:
a sleeve including an opening end and a pivot end and the opening end having a sleeve opening and the pivot end is connected to the base joint;
an rod axially moved and disposed within the sleeve, wherein one end of the rod is extended from the sleeve opening and connected to the rotating device joint; and
a force generator disposed between the rod and the pivot end of the sleeve.

20. The electronic device of claim 19, wherein the rod compresses the force generator to generate a rebounded force when the rotating device joint, the first shaft and the base joint are aligned.

21. The electronic device of claim 19, wherein the force generator includes a spring.

22. The electronic device of claim 19, wherein the force generator includes a pair of magnetic elements with the same magnetic characteristic.

23. The electronic device of claim 12, wherein the rebound device comprises:
a sleeve including an opening end and a pivot end and the opening end is in a sleeve opening and the pivot end is connected to the rotating device joint;
a rod axially and movably disposed within the sleeve and one end of the rod is extended from the sleeve opening and connected to the rotating device joint; and
a force generator disposed between the rod and the pivot end of the sleeve.
